(19) United States
(12) Patent Application Publication
(10) Pub. No.: US 2025/0029070 A1
(43) Pub. Date: Jan. 23, 2025

(54) SYSTEMS AND METHODS FOR COORDINATING MAINTENANCE OF VEHICLES

(71) Applicant: THE BOEING COMPANY, Arlington, VA (US)

(72) Inventors: Kemal Baris Tan, Vancouver (CA); Xu Xia Zhong, Richmond (CA); Duc Minh Nguyen, Coquitlam (CA); Jillian Stacey Chua, Vancouver (CA); Qi Fan Zhu, Surrey (CA); Sakina Nazarali, Surrey (CA); Brenda Shu, New Westminster (CA); Nayef Ahmad, Toronto (CA)

(73) Assignee: THE BOEING COMPANY, Arlington, VA (US)

(21) Appl. No.: 18/353,141

(22) Filed: Jul. 17, 2023

(51) Int. Cl. G06Q 10/20; G07C 5/00

(52) U.S. Cl. CPC G06Q 10/20; G07C 5/006; B64F 5/40

(57) ABSTRACT

A system and a method include a maintenance control unit configured to: receive a fault message regarding one or more components of an aircraft, determine a priority from the fault message, determine one or more parts for maintenance from the fault message, and determine a time and a location for the maintenance based on the priority and location of the one or more parts.

### FIELD OF THE DISCLOSURE

Examples of the present disclosure generally relate to systems and methods for coordinating maintenance operations for vehicles, such as aircraft.

### BACKGROUND OF THE DISCLOSURE

Aircraft are used to transport passengers and cargo between various locations. Numerous aircraft depart from and arrive at a typical airport every day.

Each aircraft includes numerous components, such as mechanical systems, electrical systems, and the like. As examples, an aircraft includes wings having flight control surfaces, a flight control system (including a flight computer), electronic systems (including monitors, speakers, and the like) within an internal cabin, landing gear, wheels, and the like. As can be appreciated, the numerous components of an aircraft are continually monitored and checked to ensure that they are in proper working condition. At various times, the components undergo scheduled maintenance.

One or more individuals typically coordinate a location, time, and required parts for maintenance. Such a process is time and labor intensive, and may cause delays in a flight schedule. Unscheduled maintenance events can be costly for airlines due to schedule interruptions. A component in need of maintenance and/or replacement can cause one or more flights of an aircraft to be delayed. For example, one or more parts may need to be procured, and a maintenance event scheduled. The part(s) may not be readily available at a particular location. As such, one or more parts may need to be ordered and moved between different locations.

### SUMMARY OF THE DISCLOSURE

A need exists for a system and a method for effectively and efficiently coordinating maintenance for vehicles, such as aircraft.

With that need in mind, certain examples of the present disclosure provide a system including a maintenance control unit configured to: receive a fault message regarding one or more components of an aircraft, determine a priority from the fault message, determine one or more parts for maintenance from the fault message, and determine a time and a location for the maintenance based on the priority and location of the one or more parts.

In at least one example, the maintenance control unit is further configured to provide a recommendation for the time and the location of the maintenance. In at least one example, the maintenance control unit is further configured to automatically schedule the time and the location for the maintenance.

The system can also include a user interface including a display. The maintenance control unit is in communication with the user interface. The maintenance control unit is further configured to show the time and the location for the maintenance on the display.

The system can also include an inventory database. The maintenance control unit is in communication with the inventory database. The inventory database includes information regarding the one or more parts.

The system can also include a flight schedule database. The maintenance control unit is in communication with the flight schedule database. The flight schedule database includes information regarding a flight schedule for the aircraft and other aircraft.

In at least one example, the priority includes one of immediate attention, deferred attention, or predicted attention. When the priority is immediate attention, the location of the maintenance is at a current location of the aircraft, and the time of the maintenance is before another flight of the aircraft. When the priority is one of deferred attention or predicted attention, the location of the maintenance is at one of a current location of the aircraft or a future location of the aircraft.

The maintenance control unit can be further configured to schedule delivery of the one or more parts at the location.

The maintenance control unit can be further configured to automatically operate one or more aspects of the aircraft based on the time and location of the maintenance.

The maintenance control unit can be an artificial intelligence or machine learning system.

Certain examples of the present disclosure provide a method including receiving, by a maintenance control unit, a fault message regarding one or more components of an aircraft; determining, by the maintenance control unit, a priority from the fault message; determining, by the maintenance control unit, one or more parts for maintenance from the fault message; and determining, by the maintenance control unit, a time and a location for the maintenance based on the priority and location of the one or more parts.

Certain examples of the present disclosure provide a non-transitory computer-readable storage medium comprising executable instructions that, in response to execution, cause one or more control units comprising a processor, to perform operations including: receiving a fault message regarding one or more components of an aircraft; determining a priority from the fault message; determining one or more parts for maintenance from the fault message; and determining a time and a location for the maintenance based on the priority and location of the one or more parts.

### BRIEF DESCRIPTION OF THE DRAWINGS

FIG. 1 illustrates a schematic block diagram of a system for coordinating maintenance for aircraft, according to an example of the present disclosure.

FIG. 2 illustrates a flow chart of a method for coordinating maintenance for aircraft, according to an example of the present disclosure.

FIG. 3 illustrates a schematic block diagram of a control unit, according to an example of the present disclosure.

FIG. 4 illustrates a perspective front view of an aircraft, according to an example of the present disclosure.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

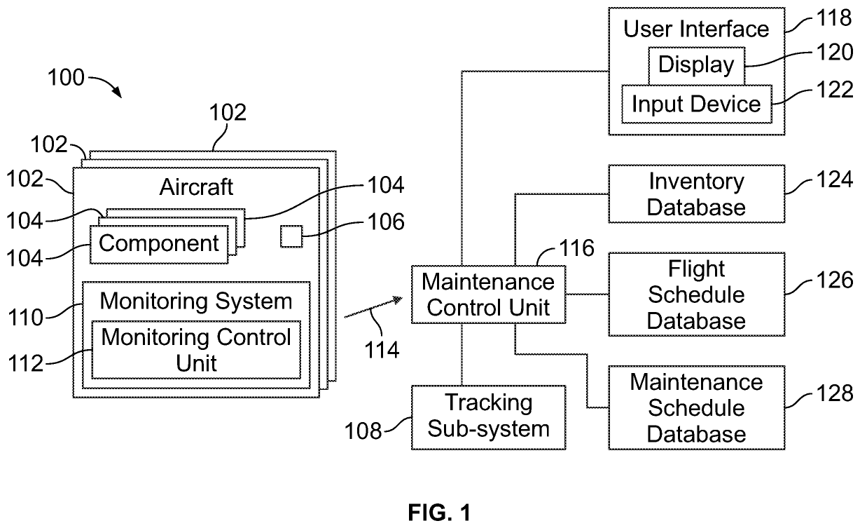

FIG. 1 illustrates a schematic block diagram of a system 100 for coordinating maintenance for aircraft 102, according to an example of the present disclosure. The system 100 can be configured to track and monitor numerous aircraft 102, such as all aircraft 102 of an airline, all aircraft 102 within a region, state, country, hemisphere, and/or the like. As another example, the system can be configured to track and monitor aircraft 102 worldwide. As another example, the system 100 can be configured to track and monitor a smaller number of aircraft 102, such as twenty or less aircraft. As another example, the system 100 can be configured to track and monitor a single aircraft.

Each aircraft 102 includes numerous components 104. The components 104 include mechanical, electrical, hydraulic, and the like systems, devices, and the like. For example, the components 104 include a fuselage, wings, control surfaces, a flight computer, landing gear, passenger service units, electronic entertainment systems, and the like. The aircraft 102 also include one or more position sensors 106 that are detected and tracked by a tracking sub-system 108. For example, the tracking sub-system 108 can be a radar sub-system. As another example, the tracking sub-system 108 can be an automatic dependent surveillance-broadcast (ADS-B) sub-system.

As an example, the position sensor 106 can be an ADS-B transmitter configured to output an ADS-B OUT signal. The ADS-B OUT signal provides information regarding the aircraft 102 within an airspace. For example, the ADS-B OUT signal provides position, heading, speed, altitude, and the like for the aircraft 102. The tracking sub-system 108 is configured to receive the ADS-B OUT signals from the aircraft 102. For example, the tracking sub-system 108 includes an ADS-B receiver that is configured to receive the ADS-B OUT signals from the aircraft 102. In this example, the tracking sub-system 108 is an ADS-B tracking sub-system that determines a current position of an aircraft 102 via satellite navigation through a positional signal (that is, the ADS-B OUT signal) of the aircraft 102 output by the ADS-B transmitter. As another example, the tracking sub-system 108 can be a global positioning system.

Each aircraft 102 also includes a monitoring system 110 having a monitoring control unit 112. The monitoring control unit 112 is configured to monitor the components 104 to determine an operating condition thereof. The monitoring control unit 112 can be in communication with one or more components 104 and/or electronic systems thereof through one or more wired or wireless connections. If the monitoring control unit 112 determines that the components 104 are operating properly, the monitoring control unit 112 refrains from outputting a fault message. If, however, the monitoring control unit 112 determines that a component 104 is in need of maintenance (for example, the component104 has failed, broken, operatively diminished, is due for replacement, and/or the like), the monitoring control unit 112 outputs a fault message 114 that includes information regarding the component 104, maintenance that is required to remedy the fault, and one or more parts needed for maintenance.

The system 100 also includes a maintenance control unit 116 in communication with the aircraft 102, such as through one or more antennas, one or more transceivers, one or more radios, an information network (such as a private communication network, the Internet, etc.), and/or the like. The maintenance control unit 116 can be at a central monitoring location that is remote from the aircraft 102. For example, the maintenance control unit 116 can be at an airport.

The maintenance control unit 116 is also in communication with the tracking sub-system 108, such as through one or more wired or wireless connections. The maintenance control unit 116 can be co-located with the tracking sub-system 108. As another example, the maintenance control unit 116 is remote from the tracking sub-system 108.

The maintenance control unit 116 is also in communication with a user interface 118, such as through one or more wired or wireless connections. The user interface 118 includes a display 120 in communication with an input device 122, such as through one or more wired or wireless connections. For example, the display 120 is an electronic monitor, television, and/or the like, and the input device 122 includes one or more of a keyboard, a mouse, a stylus, and/or the like. In at least one example, the display 120 and the input device 122 are integrated as a touchscreen interface. In at least one example, the user interface 118 is a computer workstation. As another example, the user interface 118 is a handheld device, such as a smartphone, smart tablet, or the like. In at least one example, the maintenance control unit 116 and the user interface 118 are at a common location, such as at a central monitoring location. As another example, the maintenance control unit 116 and the user interface 118 are remote from one another. In at least one example, an aircraft 102 can include the user interface 118, such as within an internal cabin.

The maintenance control unit 116 is also in communication with an inventory database 124, such as through one or more wired or wireless connections. The inventory database 124 includes information regarding parts, including the identity of the parts, their availability, and their current locations. The maintenance control unit 116 and the inventory database 124 can be at a common location. As another example, the maintenance control unit 116 is remote from the inventory database 124.

The maintenance control unit 116 is also in communication with a flight schedule database 126, such as through one or more wired or wireless connections. The flight schedule database 126 includes information regarding flight schedules (including departures and arrivals at different airports) for the various aircraft 102. The maintenance control unit 116 and the flight schedule database 126 can be at a common location. As another example, the maintenance control unit 116 is remote from the flight schedule database 126.

The maintenance control unit 116 is also in communication with a maintenance schedule database 128, such as through one or more wired or wireless connections. The maintenance schedule database 128 includes information regarding currently scheduled maintenance operations for the aircraft 102. The maintenance control unit 116 and the maintenance schedule database 128 can be at a common location. As another example, the maintenance control unit 116 is remote from the maintenance schedule database 128.

In at least one example, the maintenance control unit 116 is also in communication with a resource database. The resource database includes information regarding deferrable flight hours, for example. As another example, the maintenance control unit 116 can also be in communication with an alert system, which outputs alerts regarding component anomalies, such as degradations, failures, and/or the like.

In operation, in response to detecting a fault (such as a break, reduced operational capacity, failure, and/or the like) in a component 104 of an aircraft 102, a monitoring control unit 112 of the aircraft 102 outputs a fault message 114 that includes information regarding the component 104, maintenance that is required to remedy the fault, and one or more parts needed for maintenance. The maintenance control unit 116 receives the fault message 114 from the aircraft 102. The maintenance control unit 116 determines the component 104 experiencing the fault, the maintenance required to remedy the fault, and one or more parts needed for maintenance. The maintenance control unit 116 further determines the location of the aircraft 102 through location data received from the tracking sub-system 108.

In response to receiving the fault message 114, the maintenance control unit 116 then determines a priority for the fault, such as from preprogrammed data stored in a memory. An example of the priority includes immediate attention, which requires immediate maintenance. Examples of faults indicating immediate attention include a flat tire, a non-responsive altimeter, an inoperative flap, and/or the like. Such faults require immediate maintenance before the aircraft 102 can continue to fly.

Another example of the priority for the fault includes deferred attention, which requires eventual maintenance, but the aircraft 102 can still fly a scheduled flight. Examples of faults indicating deferred attention include an inoperative monitor of a passenger entertainment unit, an oven in a galley working at reduced capacity, and/or the like. Such faults require maintenance that can be deferred, thereby allowing the aircraft 102 to fly one or more trips before the component 104 is repaired or replaced.

In at least one other example, the maintenance control unit 116 can receive the fault message 114 and determine that the component 104 is operational, but will ultimately fail over time. For example, the maintenance control unit 116 can determine from the fault message 114 that a component 104 will need replacement within a predetermined period of time (such as within three months or less), a predetermined number of flights (such as within 10 flights or less), and/or the like. The maintenance control unit 116 can predict a failure in the future, such as through artificial intelligence, machine learning, and/or the like.

As noted, the maintenance control unit 116 receives the fault message 114, and categorizes a priority for the fault experienced by the component 104, such as through data that is preprogrammed in a memory. Examples of the priority for the fault include immediate attention, deferred attention, and predicted attention.

Faults indicating immediate attention are to be remedied (for example, component repaired or replaced) with a part at a current location (for example, a current airport) of the aircraft 102. That is, a fault indicating immediate attention precludes the aircraft 102 from flying until the fault is remedied. In this case, the component is fixed at the current location of the aircraft 102 with a part that is either at the current location or is to be delivered to the current location. The part can be delivered from another aircraft that is scheduled to fly to the current location, or ordered from a supplier and delivered to the current location.

Faults indicating deferred attention can be repaired at the current location, if the part(s) is at the current location, or at a future location (such as a future arrival airport), such as whether the future location has the part(s), or another aircraft 102 delivers the part to the future location. A fault indicating deferred attention allows the aircraft 102 to continue flying according to a current flight schedule.

Similarly, faults indicating predicted attention can be repaired at the current location, or a future location. The maintenance control unit 116 predicts a future date of repair or replacement for one or more portions of the component 104.

The maintenance control unit 116 determines the priority of the fault from the fault message 114. The maintenance control unit 116 then locates the part(s) required for the subsequent maintenance within the inventory database 124, and schedules maintenance at the current location or a future location of the aircraft 102.

After determining the priority for the fault, the maintenance control unit 116 then determines the availability and location of the part(s) needed for maintenance from the inventory database 124. In particular, the inventory database 124 includes information regarding the number and location of available parts. The maintenance control unit 116 then determines if the part(s) is at the location of the aircraft 102. If the part(s) is at the location of the aircraft 102, the maintenance control unit 116 can then output a signal to the user interface 118, which can be shown on the display 120, indicating that the part(s) is available at the current location of the aircraft 102. If, however, the part(s) is not available at the current location of the aircraft 102, the maintenance control unit 116 determines a location of the part, and if the aircraft 102 will eventually be at the location. For example, the maintenance control unit 116 analyzes information in the flight schedule database 126 to determine if the aircraft 102 will be at the location of the part within an acceptable timeframe. For example, if the fault has a priority of deferred attention, the maintenance control unit 116 outputs a signal to the user interface 118, which can be shown on the display 120, scheduling the maintenance for the component 104 at the location of the part during a scheduled stop at the location, such as an airport. As another example, the maintenance control unit 116 analyzes the flight schedules of other aircraft 102 and determines that another aircraft 102 is currently at the location of the part, and will be at the location of the aircraft 102 needing the part within a particular time period, such as within a week. In this example, the maintenance control unit 116 can output a signal to the user interface 118 indicating that the part is to be loaded onto the other aircraft 102 and delivered to the aircraft 102 needing the part when they are at a common location, such as at a common airport.

As another example, if the priority of the fault requires immediate attention, the maintenance control unit 116 outputs a signal to the user interface 118 indicating that the aircraft 102 requires immediate maintenance. In such an instance, the maintenance control unit 116 schedules a maintenance operation that is to occur before another flight of the aircraft 102. The maintenance control unit 116 can have the part delivered by another aircraft 102, for example, or ordered from a supplier and delivered to the aircraft 102 at the current location.

As another example, the maintenance control unit 116 analyzes currently scheduled maintenance operations for the aircraft 102, such as via information within the maintenance schedule database 128. If the priority of the fault indicated deferred attention, the maintenance control unit 116 can schedule the additional maintenance initiated by the fault message 114 along with the currently scheduled maintenance operation, instead of scheduling another date for maintenance. For example, the maintenance control unit 116 determines that the aircraft 102 is already scheduled for a maintenance operation regarding one or more components at a particular location at a future date. If the priority of the fault indicates deferred attention, and the future date is within a time period for the deferred attention, the maintenance control unit 116 can then add the maintenance to the currently scheduled maintenance operation.

As described herein, the maintenance control unit 116 automatically schedules (without human intervention) maintenance operations for the aircraft 102. The maintenance control unit 116 outputs signals including information regarding the maintenance for the component(s) 104, including a time and location of the maintenance. In at least one example, the maintenance control unit 116 outputs the signal to the user interface 118, and shows the information (for example, time and place, as well as required part(s)) regarding the maintenance on the display 120. Optionally, the maintenance control unit 116 can output the signal directly to the aircraft 102, and the information can be shown on a display of the aircraft 102, such as a monitor within a flight deck of the aircraft 102.

As described herein, the system 100 includes the maintenance control unit 116, which is configured to (a) receive the fault message 114 regarding one or more components 104 of an aircraft 102, (b) determine a priority from the fault message 114, (c) determine one or more parts for maintenance from the fault message 114, and (d) determine a time and a location for the maintenance based on the priority and location of the one or more parts. In at least one example, the maintenance control unit 116 further provides a recommendation for the time and the location of the maintenance. In at least one example, the maintenance control unit 116 further automatically (without human intervention) schedules the time and the location for the maintenance.

The priority includes one of immediate attention, deferred attention, or predicted attention. For example, when the priority is immediate attention, the location of the maintenance is at a current location of the aircraft, and the time of the maintenance is before another flight of the aircraft. As another example, when the priority is one or deferred attention or predicted attention, the location of the maintenance can be at a current location of the aircraft or a future location of the aircraft after a future flight.

In at least one example, the maintenance control unit 116 is configured to schedule delivery of the one or more parts at the location. For example, the location for maintenance may not have the part(s). As such, the maintenance control unit 116 can automatically schedule delivery of the part(s) to the location, such as by another aircraft flying to the location.

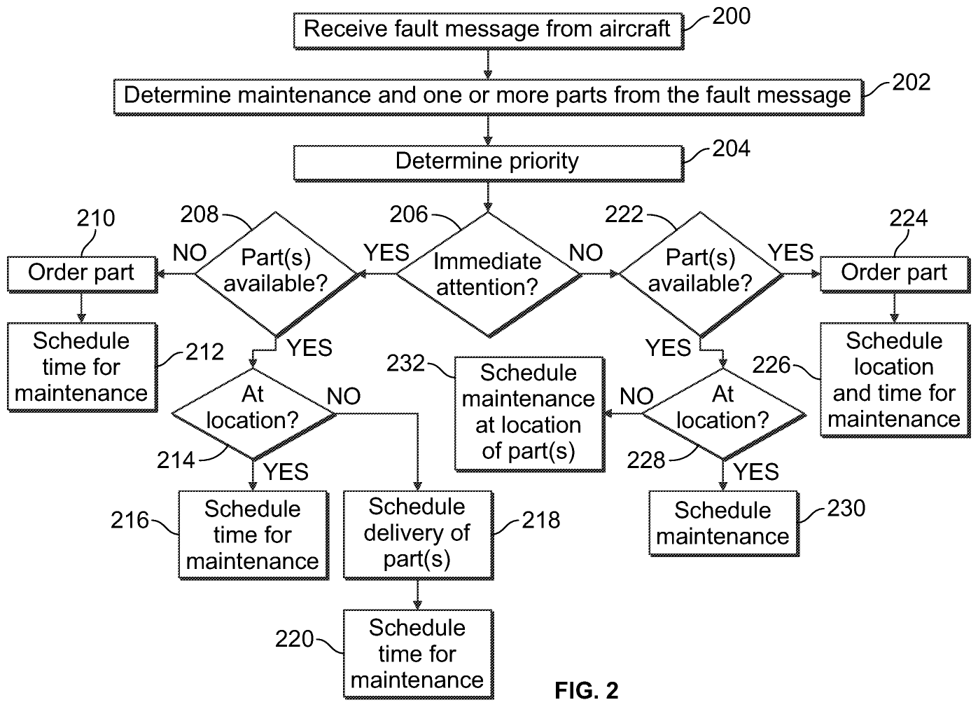

FIG. 2 illustrates a flow chart of a method for coordinating maintenance for aircraft, according to an example of the present disclosure. Referring to FIGS. 1 and 2, at 200, the maintenance control unit 116 receives a fault message 114 (related to a component 104) from an aircraft 102. At 202, the maintenance control unit 116 determines maintenance and one or more parts from the fault message 114. At 204, the maintenance control unit 116 determines a priority for the maintenance from the fault message 114. As described herein, the priority can be immediate attention, deferred attention, or predicted attention.

At 206, the maintenance control unit 116 determines if the maintenance requires immediate attention. If so, the method proceeds to 208, at which the maintenance control unit 116 analyzes information within the inventory database 124 to determine if the part(s) is available, such as within a network of parts providers, locations, and/or the like. If the part(s) is not available at 208, the maintenance control unit 116 automatically orders the part(s) (such as from a supplier), then at 212, schedules the time for maintenance at the current location of the aircraft 102.

If, however, the part(s) is available at 208, the method proceeds to 214, at which the maintenance control unit 116 determines if the part(s) is at the current location of the aircraft 102. If the part(s) is at the current location, the method proceeds from 214 to 216, at which the maintenance control unit 116 schedules the time for maintenance at the current location of the aircraft 102.

If, however, the part(s) is not at the current location of the aircraft 102 at 214, the method proceeds to 218, at which the maintenance control unit 116 schedules delivery of the part(s), such as by another aircraft 102 flying to the current location. At 220, the maintenance control unit 116 then schedules a time for the maintenance.

If, however, the priority does not indicate immediate attention at 206, the method proceeds to 222, at which the maintenance control unit 116 determines if the part(s) is available, such as within the network. If not, the method proceeds to 224, at which the maintenance control unit 116 orders the part(s), such as from a supplier. At 226, the maintenance control unit 116 then schedules a location (whether the current location or a future location of the aircraft 102, which can continue to fly scheduled routes, as the priority indicates deferred or predicted attention) and time for the maintenance.

If, however, the part(s) is available at 222, the maintenance control unit 116 then determines at 228 if the part(s) is at the current location of the aircraft 102. If the part(s) is at the current location, the method proceeds from 228 to 230, at which the maintenance control unit 116 schedules maintenance (or optionally defers maintenance to a future location).

If, however, the part(s) is not at the current location, the method proceeds from 228 to 232, at which the maintenance control unit 116 schedules maintenance at a location of the part(s). For example, a future location (such as a scheduled destination airport) of the aircraft 102 can have the part(s), and/or another aircraft 102 can deliver the part(s) to the future location.

As descried herein, the system 100 includes the maintenance control unit 116, which analyzes flight schedule information (such as via the inventory database 124), network inventory information (such as via the flight schedule database 126) and fault messages 114 to schedule maintenance (and/or provide an optimal recommendation for maintenance), including the time and location for maintenance, as well as the procurement of part(s) for maintenance. The examples described herein reduce delay and cost associated with maintenance, and substantially reduce labor time and costs, such as by saving thousands of work hours of supply chain employees.

The maintenance control unit 116 automatically acts upon fault messages 114 (such as output by monitoring control units 112 of aircraft 102), identifies relevant parts by number, and merges inventory data and flight scheduling data to provide maintenance information, whether an automatically scheduled maintenance time and location, or a recommendation thereof.

In at least one example, the maintenance control unit 116 can automatically operate one or more aspects of one or more aircraft 102 based on scheduled maintenance. For example, if the priority indicates immediate attention, the maintenance control unit 116 may automatically operate the aircraft 102 to prevent flight until the maintenance issue has been remedied. As another example, the maintenance control unit 116 can automatically operate an aircraft 102 to fly to a location for maintenance. Optionally, the maintenance control unit 116 may not automatically operate the aircraft 102.

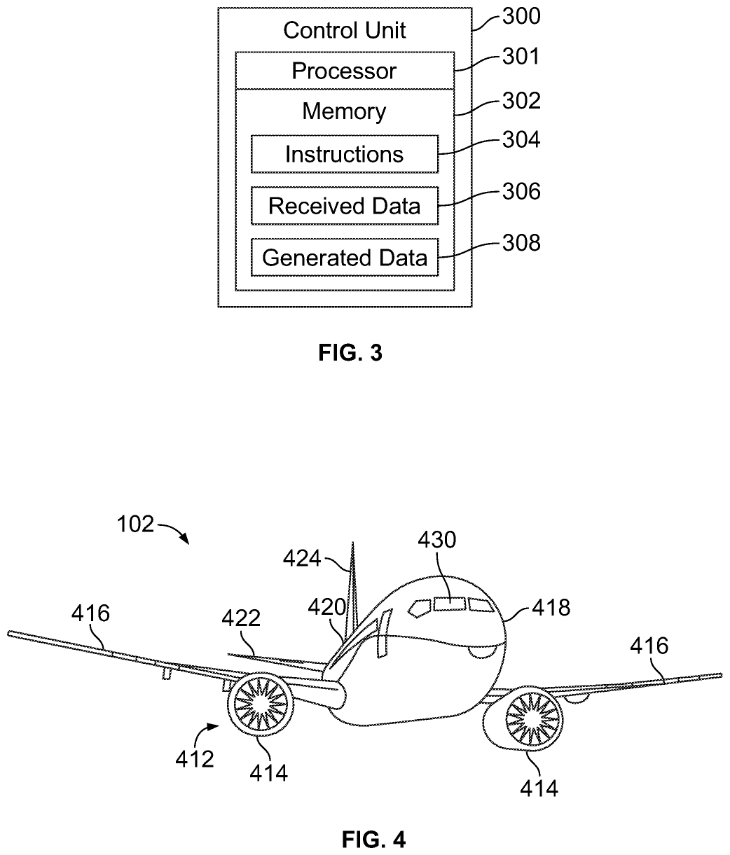

FIG. 3 illustrates a schematic block diagram of a control unit 300, according to an example of the present disclosure. Each of the maintenance control unit 116 and the monitoring control unit 112 can be configured as the control unit 300. In at least one example, the control unit 300 includes at least one processor 301 in communication with a memory 302. The memory 302 stores instructions 304, received data 306, and generated data 308. The control unit 300 shown in FIG. 3 is merely exemplary, and non-limiting.

As used herein, the term “control unit,” “central processing unit,” “CPU,” “computer,” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the monitoring control unit 112 and the maintenance control unit 116 may be or include one or more processors that are configured to control operation, as described herein.

The monitoring control unit 112 and the maintenance control unit 116 are configured to execute a set of instructions that are stored in one or more data storage units or elements (such as one or more memories), in order to process data. For example, the monitoring control unit 112 and the maintenance control unit 116 may include or be coupled to one or more memories. The data storage units may also store data or other information as desired or needed. The data storage units may be in the form of an information source or a physical memory element within a processing machine.

The set of instructions may include various commands that instruct the monitoring control unit 112 and the maintenance control unit 116 as a processing machine to perform specific operations such as the methods and processes of the various examples of the subject matter described herein. The set of instructions may be in the form of a software program. The software may be in various forms such as system software or application software. Further, the software may be in the form of a collection of separate programs, a program subset within a larger program, or a portion of a program. The software may also include modular programming in the form of object-oriented programming. The processing of input data by the processing machine may be in response to user commands, or in response to results of previous processing, or in response to a request made by another processing machine.

The diagrams of examples herein may illustrate one or more control or processing units, such as the monitoring control unit 112 and the maintenance control unit 116. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the monitoring control unit 112 and the maintenance control unit 116 may represent processing circuitry such as one or more of a field programmable gate array (FPGA), application specific integrated circuit (ASIC), microprocessor(s), and/or the like. The circuits in various examples may be configured to execute one or more algorithms to perform functions described herein. The one or more algorithms may include aspects of examples disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

Referring to FIGS. 1-3, examples of the subject disclosure provide systems and methods that allow large amounts of data to be quickly and efficiently analyzed by a computing device. For example, the maintenance control unit 116 can analyze various aspects of numerous aircraft 102, available inventory of parts, flight schedules, and the like during a particular time period. As such, large amounts of data, which may not be discernable by human beings, are being tracked and analyzed. The vast amounts of data are efficiently organized and/or analyzed by the maintenance control unit 116, as described herein. The maintenance control unit 116 analyzes the data in a relatively short time in order to quickly and efficiently determine maintenance schedules and/or recommendations for all of the aircraft 102, such as within a state, region, hemisphere, or worldwide. A human being would be incapable of efficiently analyzing such vast amounts of data in such a short time. As such, examples of the present disclosure provide increased and efficient functionality, and vastly superior performance in relation to a human being analyzing the vast amounts of data.

In at least one example, components of the system 100, such as the maintenance control unit 116, provide and/or enable a computer system to operate as a special computer system for determining and coordinating maintenance for the aircraft 102. The maintenance control unit 116 improves upon standard computing devices by determining such information in an efficient and effective manner.

In at least one example, all or part of the systems and methods described herein may be or otherwise include an artificial intelligence (AI) or machine-learning system that can automatically perform the operations of the methods also described herein. For example, the maintenance control unit 116 can be an artificial intelligence or machine learning system. These types of systems may be trained from outside information and/or self-trained to repeatedly improve the accuracy with how data is analyzed to determine and coordinate maintenance for aircraft 102. Over time, these systems can improve by determining such information with increasing accuracy and speed, thereby significantly reducing the likelihood of any potential errors. For example, the AI or machine-learning systems can learn and determine maintenance times and locations, locations and delivery of parts, and the like for the aircraft 102. The AI or machine-learning systems described herein may include technologies enabled by adaptive predictive power and that exhibit at least some degree of autonomous learning to automate and/or enhance pattern detection (for example, recognizing irregularities or regularities in data), customization (for example, generating or modifying rules to optimize record matching), and/or the like. The systems may be trained and re-trained using feedback from one or more prior analyses of the data, ensemble data, and/or other such data. Based on this feedback, the systems may be trained by adjusting one or more parameters, weights, rules, criteria, or the like, used in the analysis of the same. This process can be performed using the data and ensemble data instead of training data, and may be repeated many times to repeatedly improve the determination of maintenance operations. The training minimizes conflicts and interference by performing an iterative training algorithm, in which the systems are retrained with an updated set of data (for example, data received before, during, and/or after each flight of the aircraft 102) and based on the feedback examined prior to the most recent training of the systems. This provides a robust analysis model that can better determine situational information in a cost effective and efficient manner.

FIG. 4 illustrates a perspective front view of an aircraft 102, according to an example of the present disclosure. The aircraft 102 includes a propulsion system 412 that includes engines 414, for example. Optionally, the propulsion system 412 may include more engines 414 than shown. The engines 414 are carried by wings 416 of the aircraft 102. In other examples, the engines 414 may be carried by a fuselage 418 and/or an empennage 420. The empennage 420 may also support horizontal stabilizers 422 and a vertical stabilizer 424. The fuselage 418 of the aircraft 102 defines an internal cabin 430, which includes a flight deck or cockpit, one or more work sections (for example, galleys, personnel carry-on baggage areas, and the like), one or more passenger sections (for example, first class, business class, and coach sections), one or more lavatories, and/or the like. FIG. 4 shows an example of an aircraft 102. It is to be understood that the aircraft 102 can be sized, shaped, and configured differently than shown in FIG. 4.

Optionally, the systems and methods described herein can be used with various other types of vehicles. For example, the systems and methods can be used with respect to automobiles, buses, trains, watercraft, spacecraft, or the like.

Further, the disclosure comprises examples according to the following clauses:

Clause 1. A system comprising:
a maintenance control unit configured to:
   receive a fault message regarding one or more components of an aircraft,
   determine a priority from the fault message,
   determine one or more parts for maintenance from the fault message, and
   determine a time and a location for the maintenance based on the priority and location of the one or more parts.

Clause 2. The system of Clause 1, wherein the maintenance control unit is further configured to provide a recommendation for the time and the location of the maintenance.

Clause 3. The system of Clauses 1 or 2, wherein the maintenance control unit is further configured to automatically schedule the time and the location for the maintenance.

Clause 4. The system of any of Clauses 1-3, further comprising a user interface including a display, wherein the maintenance control unit is in communication with the user interface, and wherein the maintenance control unit is further configured to show the time and the location for the maintenance on the display.

Clause 5. The system of any of Clauses 1-4, further comprising an inventory database, wherein the maintenance control unit is in communication with the inventory database, and wherein the inventory database includes information regarding the one or more parts.

Clause 6. The system of any of Clauses 1-5, further comprising a flight schedule database, wherein the maintenance control unit is in communication with the flight schedule database, wherein the flight schedule database includes information regarding a flight schedule for the aircraft and other aircraft.

Clause 7. The system of any of Clauses 1-6, wherein the priority includes one of immediate attention, deferred attention, or predicted attention.

Clause 8. The system of Clause 7, wherein the priority is immediate attention, and wherein the location of the maintenance is at a current location of the aircraft, and the time of the maintenance is before another flight of the aircraft.

Clause 9. The system of Clauses 7 or 8, wherein the priority is one of deferred attention or predicted attention, and wherein the location of the maintenance is at one of a current location of the aircraft or a future location of the aircraft.

Clause 10. The system of any of Clauses 1-9, wherein the maintenance control unit is further configured to schedule delivery of the one or more parts at the location.

Clause 11. The system of any of Clauses 1-10, wherein the maintenance control unit is further configured to automatically operate one or more aspects of the aircraft based on the time and location of the maintenance.

Clause 12. The system of any of Clauses 1-11, wherein the maintenance control unit is an artificial intelligence or machine learning system.

Clause 13. A method comprising:
receiving, by a maintenance control unit, a fault message regarding one or more components of an aircraft;
determining, by the maintenance control unit, a priority from the fault message;
determining, by the maintenance control unit, one or more parts for maintenance from the fault message; and
determining, by the maintenance control unit, a time and a location for the maintenance based on the priority and location of the one or more parts.

Clause 14. The method of Clause 13, further comprising providing, by the maintenance control unit, a recommendation for the time and the location of the maintenance.

Clause 15. The method of Clauses 13 or 14, further comprising automatically scheduling, by the maintenance control unit, the time, and the location for the maintenance.

Clause 16. The method of any of Clauses 13-15, further comprising showing, by the maintenance control unit, the time, and the location for the maintenance on a display of a user interface.

Clause 17. The method of any of Clauses 13-16, further comprising:
communicatively coupling the maintenance control unit with an inventory database that includes information regarding the one or more parts; and
communicatively coupling the maintenance control unit with a flight schedule database that includes information regarding a flight schedule for the aircraft and other aircraft.

Clause 18. The method of any of Clauses 13-17, wherein when the priority is immediate attention, the location of the maintenance is at a current location of the aircraft, and the time of the maintenance is before another flight of the aircraft, and wherein when the priority is one of deferred attention or predicted attention, the location of the maintenance is at one of a current location of the aircraft or a future location of the aircraft.

Clause 19. The method of any of Clauses 13-18, further comprising scheduling, by the maintenance control unit, delivery of the one or more parts at the location.

Clause 20. A non-transitory computer-readable storage medium comprising executable instructions that, in response to execution, cause one or more control units comprising a processor, to perform operations comprising:
receiving a fault message regarding one or more components of an aircraft;
determining a priority from the fault message;
determining one or more parts for maintenance from the fault message; and
determining a time and a location for the maintenance based on the priority and location of the one or more parts.

As described herein, examples of the present disclosure provide systems and methods for effectively and efficiently coordinating maintenance for vehicles, such as aircraft.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A system comprising:
a maintenance control unit configured to:
receive a fault message regarding one or more components of an aircraft,
determine a priority from the fault message,
determine one or more parts for maintenance from the fault message, and
determine a time and a location for the maintenance based on the priority and location of the one or more parts.

2. The system of claim 1, wherein the maintenance control unit is further configured to provide a recommendation for the time and the location of the maintenance.

3. The system of claim 1, wherein the maintenance control unit is further configured to automatically schedule the time and the location for the maintenance.

4. The system of claim 1, further comprising a user interface including a display, wherein the maintenance control unit is in communication with the user interface, and wherein the maintenance control unit is further configured to show the time and the location for the maintenance on the display.

5. The system of claim 1, further comprising an inventory database, wherein the maintenance control unit is in communication with the inventory database, and wherein the inventory database includes information regarding the one or more parts.

6. The system of claim 1, further comprising a flight schedule database, wherein the maintenance control unit is in communication with the flight schedule database, wherein the flight schedule database includes information regarding a flight schedule for the aircraft and other aircraft.

7. The system of claim 1, wherein the priority includes one of immediate attention, deferred attention, or predicted attention.

8. The system of claim 7, wherein the priority is immediate attention, and wherein the location of the maintenance is at a current location of the aircraft, and the time of the maintenance is before another flight of the aircraft.

9. The system of claim 7, wherein the priority is one of deferred attention or predicted attention, and wherein the location of the maintenance is at one of a current location of the aircraft or a future location of the aircraft.

10. The system of claim 1, wherein the maintenance control unit is further configured to schedule delivery of the one or more parts at the location.

11. The system of claim 1, wherein the maintenance control unit is further configured to automatically operate one or more aspects of the aircraft based on the time and location of the maintenance.

12. The system of claim 1, wherein the maintenance control unit is an artificial intelligence or machine learning system.

13. A method comprising:
receiving, by a maintenance control unit, a fault message regarding one or more components of an aircraft;
determining, by the maintenance control unit, a priority from the fault message;
determining, by the maintenance control unit, one or more parts for maintenance from the fault message; and
determining, by the maintenance control unit, a time and a location for the maintenance based on the priority and location of the one or more parts.

14. The method of claim 13, further comprising providing, by the maintenance control unit, a recommendation for the time and the location of the maintenance.

15. The method of claim 13, further comprising automatically scheduling, by the maintenance control unit, the time, and the location for the maintenance.

16. The method of claim 13, further comprising showing, by the maintenance control unit, the time, and the location for the maintenance on a display of a user interface.

17. The method of claim 13, further comprising:
communicatively coupling the maintenance control unit with an inventory database that includes information regarding the one or more parts; and
communicatively coupling the maintenance control unit with a flight schedule database that includes information regarding a flight schedule for the aircraft and other aircraft.

18. The method of claim 13, wherein when the priority is immediate attention, the location of the maintenance is at a current location of the aircraft, and the time of the maintenance is before another flight of the aircraft, and wherein when the priority is one of deferred attention or predicted attention, the location of the maintenance is at one of a current location of the aircraft or a future location of the aircraft.

19. The method of claim 13, further comprising scheduling, by the maintenance control unit, delivery of the one or more parts at the location.

20. A non-transitory computer-readable storage medium comprising executable instructions that, in response to execution, cause one or more control units comprising a processor, to perform operations comprising:
receiving a fault message regarding one or more components of an aircraft;
determining a priority from the fault message;
determining one or more parts for maintenance from the fault message; and
determining a time and a location for the maintenance based on the priority and location of the one or more parts.
